(19) United States
(12) Patent Application Publication
(10) Pub. No.: US 2026/0231142 A1
(43) Pub. Date: Aug. 6, 2026

(54) SYSTEM AND METHOD FOR APPLICATION SPECIFIC SCHEDULING IN WIRELESS NETWORKS

(71) Applicant: JIO PLATFORMS LIMITED, Ahmedabad (IN)

(72) Inventors: Pradeep HIRISAVE, Bengaluru (IN); Satish JAMADAGNI, Bangalore (IN); Vinay Kumar SHRIVASTAVA, Bangalore (IN); Mathew OOMMEN, Plano, TX (US)

(73) Assignee: JIO PLATFORMS LIMITED, Ahmedabad (IN)

(21) Appl. No.: 19/150,298

(22) PCT Filed: Jan. 27, 2024
(86) PCT No.: PCT/IB2024/050771

§ 371 Date: Jul. 23, 2025

(30) Foreign Application Priority Data
Jan. 27, 2023 (IN) 202321005590

(51) Int. Cl. H04W 72/121; H04W 56/00; H04W 72/044

(52) U.S. Cl. CPC H04W 72/121; H04W 56/0015; H04W 72/044

(57) ABSTRACT

The present disclosure provides a system (108) and a method for application specific scheduling in wireless networks. The system (108) receives data timing information associated with user equipments (UEs) (112) from an application server (AS) (102). The data timing information includes an identifier associated with the UEs (112). The system (108) determines if uplink synchronization is established between a Radio Access Network (RAN) (104) and the UEs (112), and transmits scheduling information to the UEs (112) from the RAN (104). The system (108) allocates resource blocks (RBs) to the UEs (112) based on the scheduling information. The system (108) receives data from the UEs (112) in an uplink (UL) direction, where the scheduling information includes a periodicity associated with the allocation of the RBs.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for scheduling in wireless networks. More particularly, the present disclosure relates to a system and a method for application specific scheduling in wireless networks.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Fifth generation (5G) wireless technology addresses only some of the objectives that were initially visualized, but there are still quite a few issues that need to be resolved especially in accommodating industry verticals such as Massive Industrial Internet of Things (IoT), Unmanned Aerial Vehicles (UAVs) (Drones), full support for private networks, support for flexible network deployments etc. 6G IoT/Industrial Internet of Things (IIoT) is expected to see massive deployments, leading to an overhead among downlink control channels for sending scheduling information to user equipments (UEs). This overhead may affect the spectral efficiency of the network to a great extent.

5G wireless technology developed in third generation partnership project (3GPP) is meant to deliver higher peak data speeds, produce ultra-low latency while providing more reliability, massive network capacity, increased availability, and a uniform user experience to users. Higher performance and improved efficiency empower new user experiences and connect new industries. Further, 5G technology may be required to accommodate industry verticals, architectures to support private networks and support flexible network deployments, etc. A 6G network is architected to achieve an expansion of human experience across physical, biological, and digital worlds, while at the same time, enabling next-generation industrial operations environment beyond industry 4.0 in dimensions of performance such as positioning, sensing, ultra-reliability, energy efficiency, and extreme real-time. 6G networks are expected to provide novel radio and access architecture for both communications and sensing purposes. Artificial intelligence (AI) optimized wide area network and data center co-design, as well as dynamic orchestration of personalized services may be implemented to revolutionize the long tail of niche consumer interests. While demand for mobile broadband will continue to increase for consumers and enterprise alike, uptake of ultra-reliable and low latency networks will be largely driven by specialized and local use cases in conjunction with non-public networks, and often with augmented intelligence.

However, allocation of resources in the 5G and 6G networks may increase the overhead among the uplink and downlink control channels. There is, therefore, a need in the art to provide a system and a method that can mitigate the problems associated with the allocation of resources in 5G and 6G networks.

### OBJECTS OF THE INVENTION

Some of the objects of the present disclosure, which at least one embodiment herein satisfies are listed herein below.

It is an object of the present disclosure to provide a system and a method for application specific scheduling in wireless networks that introduces a mechanism to reduce a control channel overhead in downlink (DL) and uplink (UL) control channels, thereby increasing the spectral efficiency of the wireless radio network.

It is an object of the present disclosure to introduce a mechanism to share timing-related information to a user equipment (UE) for receiving the DL data so that the UE wakes up at the right instance of time.

It is an object of the present disclosure to introduce a new optimized mechanism to share control information in either the UL or in the DL direction, thereby reducing the overhead on control channels.

It is an object of the present disclosure to provide a system and a method for application specific scheduling in wireless networks, where an Application Server (AS) is synchronized with a Radio Access Node (RAN) for sending data timing information associated with the UEs connected to the RAN.

It is an object of the present disclosure to provide a system and a method for application specific scheduling in wireless networks, where the RAN receives the data timing information from the AS and provides scheduling information to the UEs with a specific periodicity.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for application specific scheduling in wireless networks. The system includes a processor communicatively coupled to a Radio access Network (RAN), and a memory operatively coupled to the processor, where the memory stores instructions to be executed by the processor. The processor receives data timing information associated with one or more user equipments (UEs) from an Application Server (AS). The data timing information includes an identifier associated with the one or more UEs and the AS is communicatively coupled to the RAN. The processor determines if uplink synchronization is established between the RAN and the one or more UEs based on the identifier. The processor, in response to a positive determination, transmits scheduling information to the one or more UEs from the RAN. The processor allocates one or more resource blocks (RBs) to the one or more UEs based on the scheduling information. The processor receives data from the one or more UEs in an uplink (UL) direction, where the scheduling information includes a periodicity associated with the allocation of the one or more RBs.

In an embodiment, the data timing information may include an application class, a data priority, and a release time associated with the one or more RBs.

In an embodiment, in response to a negative determination, the processor may restrict the transmission of the scheduling information to the one or more UEs.

In an embodiment, the processor may determine if downlink synchronization is established between the RAN and the one or more UEs, and in response to a positive determination corresponding to the downlink synchronization, allocate the one or more RBs in a downlink (DL) direction to transmit information to the one or more UEs.

In an embodiment, in response to a negative determination corresponding to the downlink synchronization, the processor may restrict the allocation of the one or more RBs in the DL direction.

In an embodiment, the scheduling information may include one or more time domain parameters, one or more frequency domain parameters, and a configuration type associated with the one or more RBs.

In an embodiment, the processor may release the allocated one or more RBs based on a trigger transmitted by the AS. The trigger may be transmitted after a lapse of the periodicity specified in the scheduling information.

In an aspect, the present disclosure relates to a method for application specific scheduling in wireless networks. The method includes receiving, by a processor associated with a system, data timing information associated with one or more UEs from an AS. The data timing information includes an identifier associated with the one or more UEs and where the AS is communicatively coupled to a RAN. The method includes determining, by the processor, if uplink synchronization is established between the RAN and the one or more UEs based on the identifier. The method includes, in response to a positive determination, transmitting, by the processor, scheduling information to the one or more UEs from the RAN. The method includes allocating, by the processor, one or more RBs to the one or more UEs based on the scheduling information. The method includes receiving, by the processor, data from the one or more UEs in an UL direction, where the scheduling information includes a periodicity associated with the allocation of the one or more RBs.

In an embodiment, the method may include restricting, by the processor, in response to a negative determination, the transmission of the scheduling information to the one or more UEs.

In an embodiment, the method may include determining, by the processor, if downlink synchronization is established between the RAN and the one or more UEs, and in response to a positive determination corresponding to the downlink synchronization, allocating, by the processor, the one or more RBs in a DL direction to transmit information to the one or more UEs.

In an embodiment, the method may include restricting, by the processor, in response to a negative determination corresponding to the downlink synchronization, the allocation of the one or more RBs in the DL direction.

In an embodiment, the method may include releasing, by the processor, the allocated one or more RBs based on a trigger transmitted by the AS. The trigger may be transmitted after a lapse of the periodicity specified in the scheduling information.

In an aspect, a UE for sending requests includes one or more processors communicatively coupled to a processor associated with a system and configured with a RAN. The one or more processors are coupled with a memory, and wherein said memory stores instructions which, when executed by the one or more processors, cause the one or more processors to transmit data timing information to the processor via a network. The data timing information includes an identifier associated with the UE and the processor is configured to receive the data timing information from the UE via an AS. The processor is configured to determine if uplink synchronization is established between the RAN and the UE based on the identifier. The processor, in response to a positive determination, transmits scheduling information to the UE from the RAN. The processor allocates one or more RBs to the UE based on the scheduling information. The processor receives data from the UE in an UL direction, where the scheduling information includes a periodicity associated with the allocation of the one or more RBs.

In an aspect, a non-transitory computer readable medium includes a processor with executable instructions that causes the processor to receive data timing information associated with one or more UEs from an AS. The data timing information includes an identifier associated with the one or more UEs and the AS is communicatively coupled to a RAN. The processor determines if uplink synchronization is established between the RAN and the one or more UEs based on the identifier. The processor, in response to a positive determination, transmits scheduling information to the one or more UEs from the RAN. The processor allocates one or more RBs to the one or more UEs based on the scheduling information. The processor receives data from the one or more UEs in an UL direction, where the scheduling information includes a periodicity associated with the allocation of the one or more RBs.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example representation (300) of a scheduling process in a wireless network, in accordance with an embodiment of the present disclosure.

FIG. 4 illustrates an example flow diagram (400) of the scheduling process, in accordance with an embodiment of the present disclosure.

FIGS. 5A-5B illustrate example flow diagrams (500A, 500B) of a scheduling process by the proposed system (108), in accordance with an embodiment of the present disclosure.

FIG. 6 illustrates an example representation (600) of an Open Radio Access Network (ORAN) logical architecture, in accordance with an embodiment of the present disclosure.

FIG. 7 illustrates an example computer system (700) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Internet of Things (IoT) application data is timed and predictable in most cases specifically when the data is from sensors, cameras, etc. which render themselves to certain optimizations in terms of scheduling resources to such IoT devices. To avoid an overhead on the end-to-end system and especially in the Radio Access Network (RAN), there are many optimizations that are possible and one such optimization is to extend a semi-persistent scheduling concept to the data generated by IoT devices. Further, in fifth generation (5G)/Beyond 5G (B5G)/sixth generation (6G) networks, one of the major entities of the end-to-end network architecture is an Application Function/Server (AS), and IoT device (or UE). These entities are aware of the context of data transmission, timing related information in terms of how periodic is the data transmission, reception shall be, and what shall be the length of such data session. Therefore, the AS is in synchronization with the periodicity and timing of the transmission of the data packets by the IoT devices using which the AS informs a scheduler (configured in the RAN) about the data timing information for a specific UE/IoT device or a group of IoT devices.

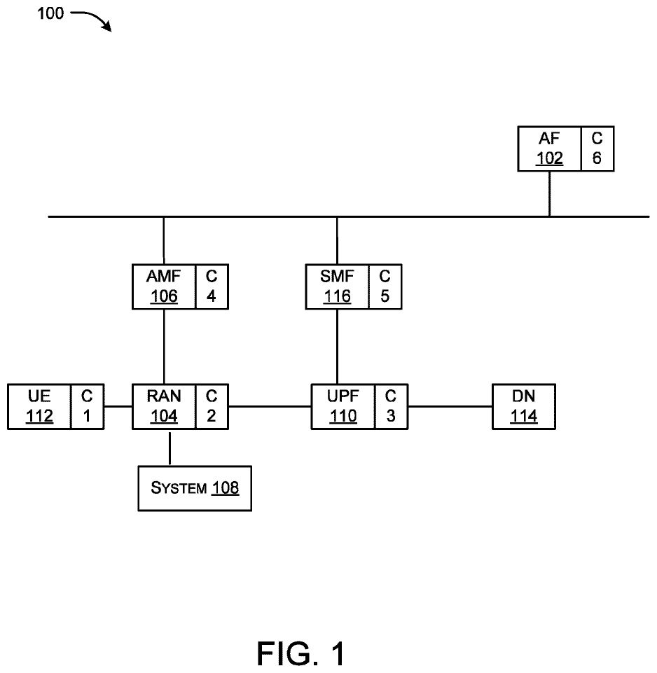

Various embodiments of the present disclosure will be explained in detail with reference to FIGS. 1-7.

FIG. 1 illustrates an example network architecture (100) for implementing a proposed system (108), in accordance with an embodiment of the present disclosure.

As illustrated in FIG. 1, the network architecture (100) may include an Application Function (102) which may be connected to a Radio Access Network (RAN) (104) through appropriate interfaces. In an embodiment, the AS (102) may correspond with a system (108) configured with the RAN (104). The system (108) may include a scheduler that may help in allocating one or more resource blocks (RBs) to one or more user equipments (UEs) (112) connected to the RAN (104). The mechanism through which the AF (102) may correspond with the RAN (104) may be via core network intermediary elements such as the Access and Mobility Management Function (AMF) (106), the Session Management Function (SMF) (116), and the User Plane Function (UPF) (110) (with a data network DN (114)) with appropriate interfaces. A person skilled in the art may understand that the one or more UEs (112) may be individually referred as the UE (112) and collectively referred as the UEs (112) throughout the disclosure.

In an embodiment, the system (108) may receive data timing information associated with the one or more UEs (112) from the AF or AS (102), where the data timing information may include an identifier associated with the one or more UEs (112). In an embodiment, the data timing information may include, but not limited to, an application class, a data priority, and a release time associated with the one or more RBs.

In an embodiment, the system (108) may determine if uplink synchronization is established between the RAN (104) and the one or more UEs (112) based on the identifier. In response to a positive determination, the system (108) may transmit scheduling information to the one or more UEs (112) from the RAN (104). In response to a negative determination, the system (108) may restrict the transmission of the scheduling information to the one or more UEs (112).

In an embodiment, the system (108) may allocate the one or more RBs to the one or more UEs (112) based on the scheduling information. The scheduling information may include, but not limited to, one or more time domain parameters, one or more frequency domain parameters, and a configuration type associated with the one or more RBs. In an embodiment, the scheduling information may include frequency domain scheduling information and time domain scheduling information.

In an embodiment, the system (108) may receive data from the one or more UEs (112) in an uplink (UL) direction, where the scheduling information may include a periodicity associated with the allocation of the one or more RBs.

In an embodiment, the system (108) may determine if downlink synchronization is established between the RAN (104) and the one or more UEs (112) and in response to a positive determination, allocate the one or more RBs in a downlink (DL) direction to transmit information to the one or more UEs (112). In response to a negative determination, the system (108) may restrict the allocation of the one or more RBs in the DL direction. This mechanism may reduce any control channel overhead specifically on the DL control channels and thereby increase the spectral efficiency of the wireless radio network. These mechanisms may be used for both periodic/aperiodic, bursty traffic, and as well for coreless networks or network with a core. The system (108), via the AS (102), may share timing related information, i.e. scheduling information to the one or more UE's (112) for receiving the DL data so that the one or more UEs (112) may wake up at the right instance of time.

In an embodiment, the system (108) may release the one or more RBs allocated based on a trigger transmitted by the AS (102), where the trigger may be transmitted to the system (108) after a lapse of the periodicity specified in the scheduling information.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

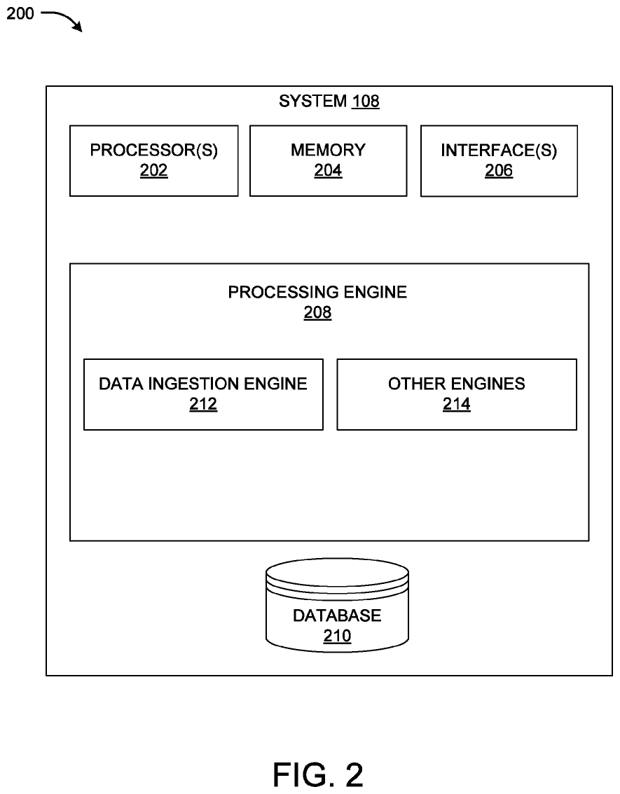

FIG. 2 illustrates an example block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data ingestion engine (212) and other engine(s) (214). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive data timing information associated with the one or more UEs (112) from an AS (102). The data timing information may be received via the data ingestion engine (212). The processor (202) may store the data timing information in the database (210). The data timing information may include an identifier associated with the one or more UEs (112).

In an embodiment, the processor (202) may determine if uplink synchronization is established between the RAN (104) and the one or more UEs (112) based on the identifier. In response to a positive determination, the processor (202) may transmit scheduling information to the one or more UEs (112) from the RAN (104). In response to a negative determination, the processor (202) may restrict the transmission of the scheduling information to the one or more UEs (112).

In an embodiment, the processor (202) may allocate the one or more RBs to the one or more UEs (112) based on the scheduling information.

In an embodiment, the processor (202) may receive data from the one or more UEs (112) in an UL direction, where the scheduling information may include a periodicity associated with the allocation of the one or more RBs.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

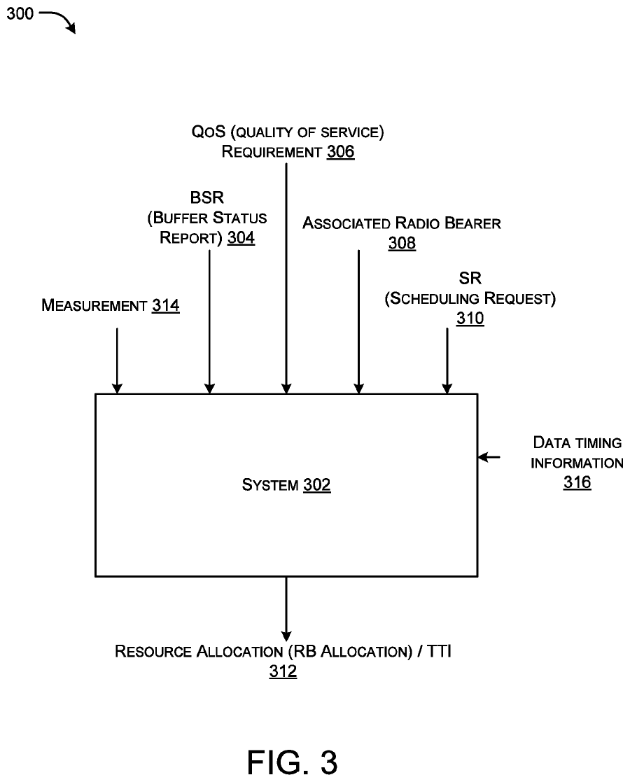

FIG. 3 illustrates an example representation (300) of a scheduling process in a wireless network, in accordance with an embodiment of the present disclosure.

In an embodiment, scheduling may include a process of allocating resources for transmitting data. As in Long-Term Evolution (LTE) (in all cellular communication), new radio (NR) scheduling may be dictated by a network and UE (112) may follow the communication from the network. The scheduling may be dependent on the many factors (including quality of service (QoS)) and not based on an application type. There may be two types of scheduling in the DL direction. One is called dynamic scheduling and the other one is semi-persistent scheduling. Dynamic scheduling is the mechanism in which each and every physical downlink shared channel (PDSCH) is scheduled by downlink control information (DCI) (DCI 1_0 or DCI 1_1). SPS is the mechanism in which the PDSCH transmission may be scheduled by a radio resource control (RRC) message.

In an embodiment, in 6G, scheduling optimizations may be important for application specific scheduling, where a scheduling process may include allocation of resources for transmitting data. As in all cellular communications, New Radio (NR) scheduling may be dictated by the network and the UE (112) following the network. An overall scheduling mechanism in NR is similar to Long-Term Evolution (LTE) scheduling, but NR may include finer granularity especially in terms of time domain scheduling at a physical layer. 6G scheduling may be similar to the NR scheduling, but may incorporate data timing information from the UE (112) for allocating the one or more RBs, as shown in FIG. 3.

In an embodiment, for the scheduler operation, the UE buffer status report (304) and the QoS (306) requirements of each UE (112) and associated radio bearers (308) may be taken into account to allocate resources between the one or more UEs (112). The system, i.e., scheduler (302) may also allocate resources based on radio conditions at the UE (112) which are known via measurements made at the gNB (base station) or communicated by the UE (112). Radio resources may be assigned in a unit of slot and the radio resources may be made up of the one or more RBs. The scheduler (302) may receive the associated radio bearers (308), the buffer status report (304), the QoS (306) requirements of each UE (112), a measurement (314) based on a scheduling request (310) sent by the UE (112), and data timing information (316). The scheduler (302) may perform resource allocation (312) per transmission time interval (TTI).

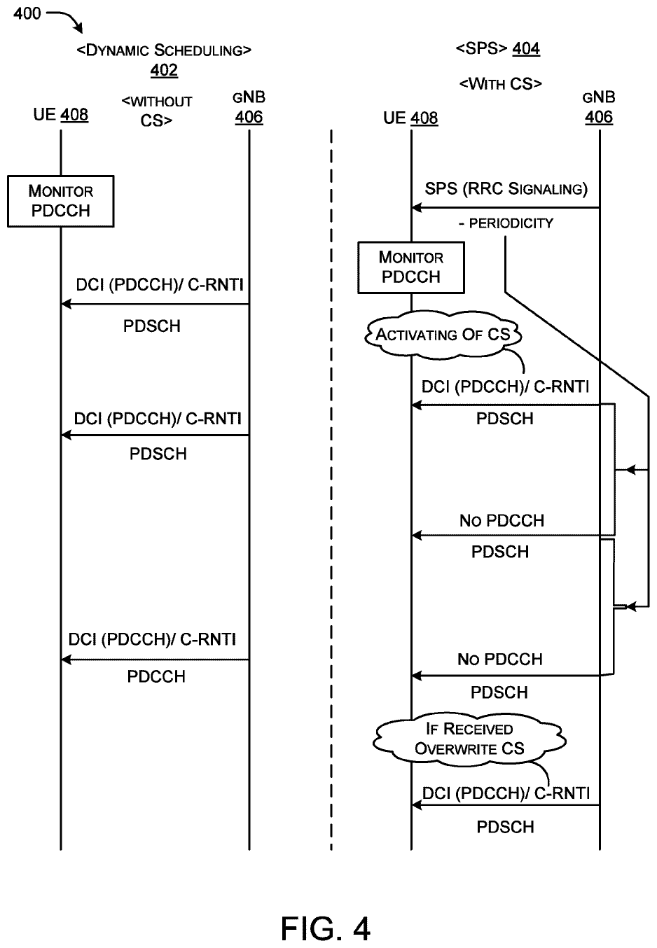

FIG. 4 illustrates an example flow diagram (400) of the scheduling process, in accordance with an embodiment of the present disclosure.

In an embodiment, as illustrated in FIG. 4, scheduling may include dynamic scheduling (402) and SPS scheduling (404). Dynamic scheduling (402) may be the mechanism in which each and every PDSCH may be scheduled by the DCI (DCI 1_0 or DCI 1_1). SPS (404) may be the mechanism in which the PDSCH transmission is scheduled by the RRC message. The SPS scheduling (404) may also be called as configured scheduling in 5G. Configured scheduling may be a mechanism in which the gNB (406) may schedule PDSCH/physical uplink shared channel (PUSCH) without using the DCI for every transmission. Further, the gNB (406) may configure all the detailed scheduling parameters in RRC and the gNB/UE (408) may transmit the PDSCH and the PUSCH according to the parameters specified in a RRC message container. This may help gNB (406) to reduce the load of physical/Media Access Control Address (PHY/MAC) scheduling. Also, IoT as a use case category may come up with many use cases which involves machine to machine (M2M) communication and machine to human communication. The scale of such devices may also be expected to be massive with that the connection density of such deployment expected to be in the millions of devices per square kilometre (Sq. Km). IoT data may also be timed and predictable in most cases specifically when the data is from sensors, cameras, etc. which may render themselves to certain optimizations in terms of scheduling resources to such IoT devices. To avoid an overhead on the end-to-end system and especially in the RAN, the SPS scheduling (404) may be used for data generated by IoT devices.

Further, the SPS scheduling (404) may help reduce the control channel overhead in a wireless network by having radio resources scheduled prior to transmission for certain applications like voice/video calls. Such persistent scheduling may help UEs (408) to use the radio resources especially when there is a need to transfer data packets continuously without waiting for scheduling information at every instance. In scenarios like voice/video calling, there may be a data packet that needs to be sent as per the desired QoS configured. If dynamic scheduling (402) is used, then the control channels used in the DL may encounter a huge overhead and reduce the overall spectrum efficiency. Furthermore, in IoT/IIoT scenarios, there may be a case where UEs (408) need to send data packets in short bursts, periodic, or aperiodic. In the current scenario, the network may choose dynamic scheduling (402). But, in IoT, with massive scale of deployments, dynamic scheduling (402) may be a big signaling overhead. This may reduce the network/spectrum efficiency to a great extent. One of the ways to improve the spectral efficiency is by reducing the overhead on the radio resources that are used by the control channel information in either of the direction. Most of the resources are also used in sharing the scheduling information in the DL control channels so that UEs (408) know exactly what radio resources (in both time and frequency domain) to use for data transmission. Therefore, sharing control information in either the UL or in the DL direction may reduce the overhead on the control channels using radio resources.

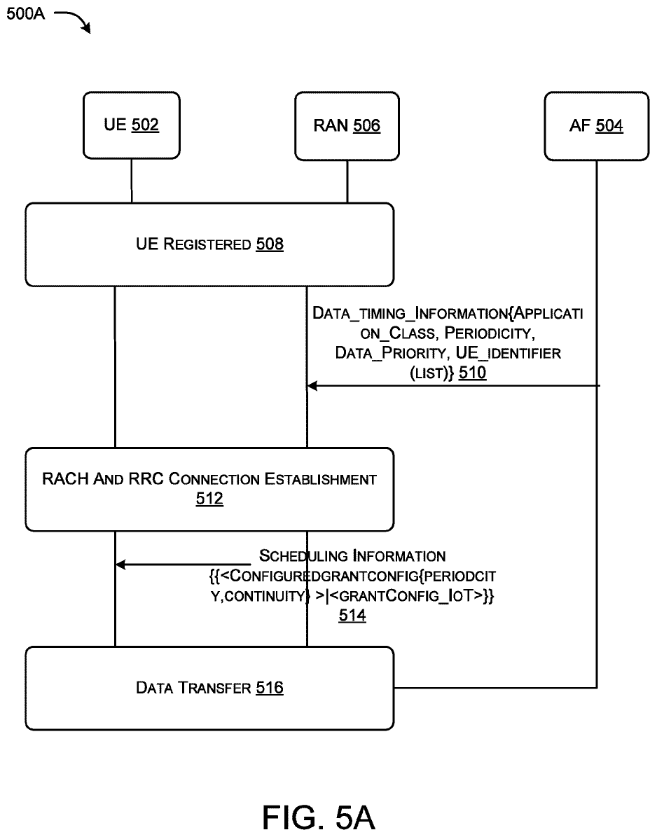

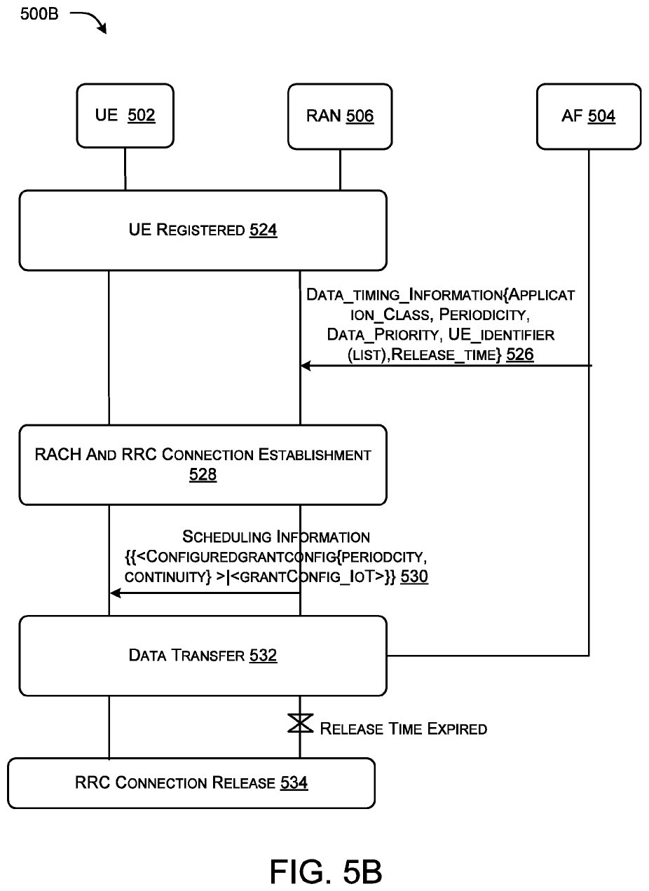

FIGS. 5A-5B illustrate example flow diagrams (500A, 500B) of a scheduling process by the proposed system (108), in accordance with an embodiment of the present disclosure.

As illustrated in FIG. 5A, in an embodiment, a UE (502) and an AF (504) may always be in synchronization about the periodicity and timing of the transmission of the data packets by the IoT device/UE (502). The AF (504) may inform the system (108), i.e., scheduler about the data timing information for a specific UE (502)/IoT device or a group of IoT devices. The scheduler (108) may decide on a set of radio resources to be allocated to the UE (502) or used by a given UE (502) for specific transmission slots in the UL. The scheduler (108) may also provide specific DL slots whereby the UE (502) may wake up at those times to receive specific data. The DL transmission slots may be indicated as Discontinuous Reception (DRX) cycles to the IoT device (502).

In an embodiment, the data timing information may include a periodicity of data transmission (data timing information) from the UE (502). The UE identifier may also associate with the data timing information for a given UE (502) so that the identifier may be transferred to the scheduler (108). The AF (504) may send a message to a mobility management entity (MME) via NEF and MME may forward the message to the respective RAN (506) to which a given UE (502) is attached. The data timing information may include the following:

```
Data_timing_information ::{ Application_class== {Periodic, Busty,
Continuous, ... },
  Periodicity == 1234353 ms,
  Data_Priority == {High, Medium, Low},
  UE_Identifier::{<IMSI_list=={{12345678912334,1111111111
  11},{...} > | <TMSI_list>|<P-TMSI_list>|<IMEI_list>,... }
  Release_Time == {123456789ms}
Scheduling_Information :: { <Time Domain Parameters>,
  <Frequency Domain Parameters>,
  <CS type = 1 / 2>}
```

In an embodiment, the AF (504) may also indicate the UE identifier to the RAN (506) so that RAN (506) may schedule the UE (502) based on the value set in the identifier. The UE identifiers may include, but not limited to, an International Mobile Subscriber Identity (IMSI), a temporary IMSI (TMSI), a packet temporary (TMSI), and an International Mobile Equipment Identity (IMEI). Based on the UE identifier sent by the AF (504), the RAN (506) may share the scheduling information accordingly with the appropriate UL grants as shown below.

```
ConfiguredGrantConfig::={..........
  periodicity ENUMERATED { sym2, sym7, sym1x14, sym2x14, sym4x14, sym5x14,
  sym8x14, sym10x14, sym16x14, sym20x14, sym32x14, sym40x14, sym64x14,
  sym80x14, sym128x14, sym160x14, sym256x14, sym320x14, sym512x14, sym640x14,
  sym1024x14, sym1280x14, sym2560x14, sym5120x14, sym6, sym1x12, sym2x12,
  sym4x12, sym5x12, sym8x12, sym10x12, sym16x12, sym20x12, sym32x12, sym40x12,
  sym64x12, sym80x12, sym128x12, sym160x12, sym256x12, sym320x12, sym512x12,
  sym640x12, sym1280x12, sym2560x12, { <Periodicity = 1234353 ms>},{<Continuity
  =123456ms>,...}},}
  Extended_Periodicity_ENUMERATED {{ <Periodicity == 1234353 ms>},{<Continuity
  =123456ms>,...}},} ...}
```

In an embodiment, the identifier may be dependent at the AF (504). A list of the identifiers may be sent as part of the data timing information. In an ideal situation, the AF (504) may communicate with the 5GS or 6G network via the NEF to MME to RAN (506). The MME, based on the context and a Routing Area Update/Tracking Area Update (RAU/TAU) from the UE (502), may identify the UE (502) belonging to a RAN node and the RAN (506) may further share the scheduling information to the respective UE (502) under the RAN (506). Further, adding a new enumeration value to indicate the same to be used once in X hours, the below

ConfiguredGrantConfig::={periodicity ENUMERATED {sym2, sym7, sym1x14, sym2x14, sym4x14, sym5x14, sym8x14, sym10x14, sym16x14, sym20x14, sym32x14, sym40x14, sym64x14, sym80x14, sym128x14, sym160x14, sym256x14, sym320x14, sym512x14, sym640x14, sym1024x14, sym1280x14, sym2560x14, sym5120x14, sym6, sym1x12, sym2x12, sym4x12, sym5x12, sym8x12, sym10x12, sym16x12, sym20x12, sym32x12, sym40x12, sym64x12, sym80x12, sym128x12, sym160x12, sym256x12, sym320x12, sym512x12, sym640x12, sym1280x12, sym2560x12, {<Periodicity=1234353 ms>}, {<Continuity=123456 ms>, . . . }},}
Extended_Periodicity_ENUMERATED {{<Periodicity==1234353 ms>}, {<Continuity=123456 ms>, . . . }}, . . . }
New IE: GrantConfig_IoT=={Sym_Config_USE=<0/1>, {<Periodicity==1234353 ms>}, {>}, <Continuity=123456 ms>}, . . . }
Sym_Config_USE->indicates if the UE (502) may use the configuration grant shared in the scheduling information at the periodicity set by the identifier (IE) “Periodicity”
If the value is “1”, the UE (502) may use the configuration grant
If the value is “0”, the UE (502) may not use the configuration grant and wait for the next configuration to be set with above IE set to 1.

Further, continuity may be used to indicate if the grant can be used continuously for time mentioned as part of the value in the IE.

Referring to FIG. 5A, the flow diagram 500A may include the following steps:

At step 508: The UE (502) may be registered with the RAN (506).

At step 510: The AF (504) may send the data timing information of the UE (502) to the RAN (506).

At step 512: The UE (502) may set up the random access channel (RACH) and the RRC connection with the RAN (506).

At step 514: Once the RACH and the RRC connections have been established, the RAN (506) may send the scheduling information to the UE (502).

At step 516: Data transfer may be established between the UE (502) and the RAN (506).

In another embodiment, the AF (504) may be a hosted function by a network operator and the AF (504) may correspond with the scheduler (108) residing in the RAN (506) via a set of interfaces. In another embodiment, the AF (504) may be outside the domain of the network operator and the scheduling time information may be provided to the RAN (506) via a network exposure function (NEF). Further, the AF (504) may utilize DRX for specific applications, but determining an UL data schedule and sharing may be performed via one or more available network interfaces. In yet another embodiment, the RAN (506) may itself determine the periodicity in the UL data for a specific UE (502) either in a RAN node or in a Radio Intelligent Controller and the periodicity may be transferred to the scheduler (108) for appropriate persistent/semi persistent scheduling decisions by the schedulers.

As illustrated in FIG. 500B, in another embodiment, for a periodic data transmission use case, at the first instance itself, a radio resource may be allocated to the UE (502) for the next few hours based on the timing related information as received from the AF (502). Once a connection is established and context is set for a continuous transmission or bursty transmission, the resources may be used as per the configuration grant shared by the scheduler (108). The resources may be released based on the trigger from the AS/AF (502).

In an embodiment, the flow diagram 500B may include the following steps:

At step 524: The UE (502) may be registered with the RAN (506).

At step 526: The AS (502) may send the data timing information of the UE (502) to the RAN (506).

At step 528: The UE (502) may set up the RACH and the RRC connection with the RAN (506).

At step 530: Once the RACH and the RRC connections have been established, the RAN (506) may send the scheduling information to the UE (502).

At step 532: Data transfer may be established between the UE (502) and the RAN (506).

At step 534: Once a release time specified in the data timing information has expired, the AS (502) may send a trigger to the RAN (506) to release the one or more RBs. This may include the RRC release associated with the UE (502).

Further, the data timing information may be provided as follows.

Data_timing_information::{::{Application_class=={Periodic, Bursty, Continuous, . . . }, Periodicity 1234353 ms,Data_Priority=={High, Medium, Low}, UE_Identifier: {<IMSI_list={1234567891234,111111111111}, { . . . }>|<TMSI_list>|<P-TMSI_list>|<IMEI_list>,}} Release_Time=={123456789 ms}}

The New IE may be provided as GrantConfig_IoT=={Sym_Config_USE=<0/1>, {<Periodicity==1234353 ms>}, {>}, <Continuity=123456 ms>}, . . . } Sym_Config_USE may indicate if the UE (502) may use the configuration grant shared in the scheduling information at the periodicity set by the IE “Periodicity”
If the value is “1”, the UE (502) may use the configuration grant
If the value is “0”, the UE (502) may not use the configuration grant and wait for the next configuration to be set with above IE set to 1.

Further, continuity may be used to indicate if the configuration grant may be used continuously for time mentioned as part of the value in the IE. The continuity IE may provide the information to the UE (502) about the grants that can be used for x time for data type, continuous.

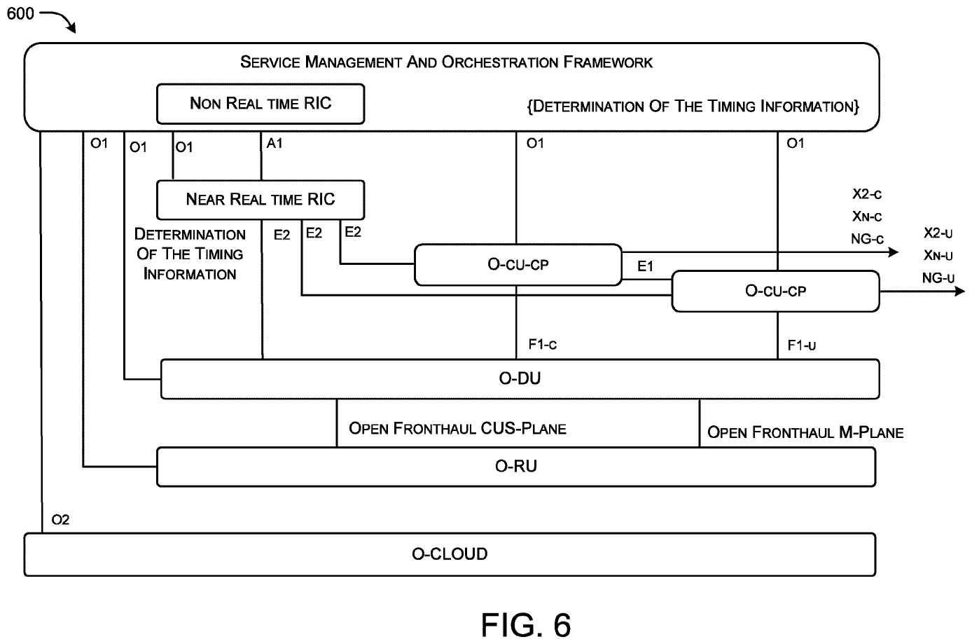

FIG. 6 illustrates an example diagram (600) of an Open Radio Access Network (ORAN) logical architecture, in accordance with an embodiment of the present disclosure.

As illustrated in FIG. 6, in an embodiment, the O-RAN architecture may include determination of an application specific timing information. UL transmission of specific devices may be performed at the non-real time RAN intelligent controller (RIC) or at the near real-time RIC. Further, the UL transmission of specific devices provided to the RAN node via the appropriate interfaces (O1, A1, E2, F1c interfaces) is shown in FIG. 6. The Service Management and Orchestration (SMO) may also obtain the application specific/UE specific UL transmission information via any proprietary interface between the SMO and the application server. The DL data timing information may be determined by the non-real time RIC or the near real-time RIC using certain artificial intelligence/machine learning (AI/ML) algorithms. Further, the DL data timing information may be provided to the RAN node over the appropriate interfaces.

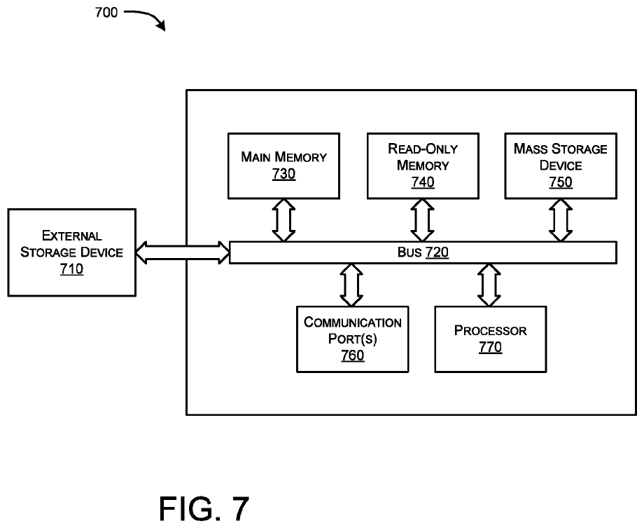

FIG. 7 illustrates an exemplary computer system (700) in which or with which embodiments of the present disclosure may be implemented.

As shown in FIG. 7, the computer system (700) may include an external storage device (710), a bus (720), a main memory (730), a read-only memory (740), a mass storage device (750), a communication port(s) (760), and a processor (770). A person skilled in the art will appreciate that the computer system (700) may include more than one processor and communication ports. The processor (770) may include various modules associated with embodiments of the present disclosure. The communication port(s) (760) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (760) may be chosen depending on a network, such as a Local Area Network (LAN), Wide Area Network (WAN), or any network to which the computer system (700) connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chip for storing static information e.g., start-up or basic input/output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (720) may communicatively couple the processor(s) (770) with the other memory, storage, and communication blocks. The bus (720) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (770) to the computer system (700).

In another embodiment, operator and administrative interfaces, e.g., a display, keyboard, and cursor control device may also be coupled to the bus (720) to support direct operator interaction with the computer system (700). Other operator and administrative interfaces can be provided through network connections connected through the communication port(s) (760). Components described above are meant only to exemplify various possibilities. In no way should the aforementioned exemplary computer system (700) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure reduces any control channel overhead mong the downlink (DL) and the uplink (UL) control channels, thereby increasing the spectral efficiency of the wireless radio network.

The present disclosure provides a system and a method for application specific scheduling in wireless networks that shares timing related information to a user equipment (UE) for receiving the DL data so that the UE wakes up at the right instance of time.

The present disclosure increases the spectrum efficiency and thus the connection density with an optimized way of scheduling the resources irrespective of a mode of operation.

We claim:

1. A system (108) for application specific scheduling in wireless networks, the system (108) comprising:
a processor (202) communicatively coupled to a radio access node (RAN) (104); and
a memory (204) operatively coupled with the processor (202), wherein the memory (204) stores instructions which, when executed by the processor (202), cause the processor (202) to:
receive data timing information associated with one or more user equipments (UEs) (112) from an Application Server (AS) (102), wherein the data timing information comprises an identifier associated with the one or more UEs (112), and wherein the AS (102) is communicatively coupled to the RAN (104);
determine if uplink synchronization is established between the RAN (104) and the one or more UEs (112) based on the identifier;
in response to a positive determination, transmit scheduling information to the one or more UEs (112) from the RAN (104);
allocate one or more resource blocks (RBs) to the one or more UEs (112) based on the scheduling information, wherein the scheduling information comprises a periodicity associated with the allocation of the one or more RBs; and
receive data from the one or more UEs (112) in an uplink (UL) direction based on the allocated one or more RBs.

2. The system (108) as claimed in claim 1, wherein the data timing information comprises at least one of: an application class, a data priority, and a release time associated with the one or more RBs.

3. The system (108) as claimed in claim 1, wherein, in response to a negative determination, the processor (202) is to restrict the transmission of the scheduling information to the one or more UEs (112).

4. The system (108) as claimed in claim 1, wherein the processor (202) is to:
determine if downlink synchronization is established between the RAN (104) and the one or more UEs (112); and
in response to a positive determination corresponding to the downlink synchronization, allocate the one or more RBs in a downlink (DL) direction to transmit information to the one or more UEs (112).

5. The system (108) as claimed in claim 4, wherein, in response to a negative determination corresponding to the downlink synchronization, the processor (202) is to restrict the allocation of the one or more RBs in the DL direction.

6. The system (108) as claimed in claim 1, wherein the scheduling information comprises at least one of: one or more time domain parameters, one or more frequency domain parameters, and a configuration type associated with the one or more RBs.

7. The system (108) as claimed in claim 1, wherein the processor (202) is to release the allocated one or more RBs based on a trigger transmitted by the AS (102), wherein the trigger is transmitted after a lapse of the periodicity specified in the scheduling information.

8. A method for application specific scheduling in wireless networks, the method comprising:
receiving, by a processor (202) associated with a system (108), data timing information associated with one or more user equipments (UEs) (112) from an Application Server (AS) (102), wherein the data timing information comprises an identifier associated with the one or more UEs (112), and wherein the AS (102) is communicatively coupled to a Radio Access Network (RAN) (104);
determining, by the processor (202), if uplink synchronization is established between the RAN (104) and the one or more UEs (112) based on the identifier;
in response to a positive determination, transmitting, by the processor (202), scheduling information to the one or more UEs (112) from the RAN (104);
allocating, by the processor (202), one or more resource blocks (RBs) to the one or more UEs (112) based on the scheduling information, wherein the scheduling information comprises a periodicity associated with the allocation of the one or more RBs; and
receiving, by the processor (202), data from the one or more UEs (112) in an uplink (UL) direction based on the allocated one or more RBs.

9. The method as claimed in claim 8, comprising, in response to a negative determination, restricting, by the processor (202), the transmission of the scheduling information to the one or more UEs (112).

10. The method as claimed in claim 8, comprising determining, by the processor (202), if downlink synchronization is established between the RAN (104) and the one or more UEs (112), in response to a positive determination corresponding to the downlink synchronization, allocating, by the processor (202), the one or more RBs in a downlink (DL) direction to transmit information to the one or more UEs (112), and in response to a negative determination corresponding to the downlink synchronization, restricting, by the processor (202), the allocation of the one or more RBs in the DL direction.

11. The method as claimed in claim 8, comprising releasing, by the processor (202), the allocated one or more RBs allocated based on a trigger transmitted by the AS (102), wherein the trigger is transmitted after a lapse of the periodicity specified in the scheduling information.

12. A user equipment (UE) (112) for sending requests, the UE (112) comprising:
one or more processors communicatively coupled to a processor (202) associated with a system (108) and configured with a Radio Access Network (RAN) (104), wherein the one or more processors are coupled with a memory, and wherein the memory stores instructions which, when executed by the one or more processors, cause the one or more processors to:
transmit data timing information to the processor (202) via a network (106), wherein the data timing information comprises an identifier associated with the UE (112), and wherein the processor (202) is configured to:
receive the data timing information from the UE (112) via an Application Server (AS) (102);
determine if uplink synchronization is established between the RAN (104) and the UE (112) based on the identifier;
in response to a positive determination, transmit scheduling information to the UE (112) from the RAN (104);
allocate one or more resource blocks (RBs) to the UE (112) based on the scheduling information; and
receive data from the UE (112) in an uplink (UL) direction, wherein the scheduling information comprises a periodicity associated with the allocation of the one or more RBs.

13. A non-transitory computer readable medium comprising a processor with executable instructions, causing the processor to:
receive data timing information associated with one or more user equipments (UEs) (112) from an Application Server (AS) (102), wherein the data timing information comprises an identifier associated with the one or more UEs (112), and wherein the AS (102) is communicatively coupled to a Radio Access Network (RAN) (104);
determine if uplink synchronization is established between the RAN (104) and the one or more UEs (112) based on the identifier;
in response to a positive determination, transmit scheduling information to the one or more UEs (112) from the RAN (104);
allocate one or more resource blocks (RBs) to the one or more UEs (112) based on the scheduling information; and
receive data from the one or more UEs (112) in an uplink (UL) direction, wherein the scheduling information comprises a periodicity associated with the allocation of the one or more RBs.
